(19) United States
(12) Patent Application Publication
(10) Pub. No.: US 2006/0080660 A1
(43) Pub. Date: Apr. 13, 2006

(54) System and method for disabling the use of hyper-threading in the processor of a computer system

(75) Inventor: Ramesh Radhakrishnan, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/960,336

(22) Filed: Oct. 7, 2004

(51) Int. Cl. G06F 9/46

(52) U.S. Cl. 718/100

(57) ABSTRACT

A system and method is disclosed for disabling a hyper-threading mode in the processor of a computer system when it is determined that the processor of the computer system is being adversely affected by the execution of a software application in a multi-threaded execution mode. The system and method disclosed herein involves measurement or certain performance metrics of the processor. On the basis of this performance data, the hyper-threading functionality of the processor may be disabled.

### TECHNICAL FIELD

The present disclosure relates generally to computer systems and information handling systems, and, more specifically, to a system and method for disabling the use of hyper-threading in an information handling system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A processor a computer system may employ hyper-threading technology to execute in parallel threads from multi-threaded software applications. Hyper-threading technology involves the execution of multiple threads of a single software application or multiple software applications on a single processor. Hyper-threading technology exists in some processor products of Intel Corporation of Santa Clara, Calif. Hyper-threading is sometimes referred to as multi-threaded execution. An advantage of hyper-threading technology is the greater and more efficient use of the resources of a processor. One advantage of hyper-threading technology is that the parallel processing of multiple threads involves processor resources that would be idle in the absence of hyper-threading technology. The use of hyper-threading technology in a processor may improve the performance of some software applications executing on the processor. One disadvantage of hyper-threading technology is that the performance of a computer system or a software application may be negatively affected if hyper-threading technology is employed for the execution of a software application that is not optimized for multi-threaded execution.

### SUMMARY

In accordance with the present disclosure, a system and method is disclosed for disabling a hyper-threading mode in the processor of a computer system when it is determined that the processor of the computer system is being adversely affected by the execution of a software application in a multi-threaded execution mode. The system and method disclosed herein involves measurement or certain performance metrics of the processor. On the basis of this performance data, the hyper-threading functionality of the processor may be disabled. The disabling of the hyper-threading mode in the processor may be accomplished by disabling each of the logical processors of the computer system.

The system and method disclosed herein is technically advantageous because it provides a system and methodology for transitioning the processor of the computer system from multi-thread execution to single thread execution. Some software applications are not optimized for multi-threaded execution, and the execution of these software applications in a hyper-threading mode may have the result of degrading, rather than improve, the performance of the computer system. The system and method disclosed herein identifies the condition in which the processor's performance is degraded by the use of a hyper-threading mode of execution, and disable the use of hyper-threading in the processor.

Another technical advantage of the system and method disclosed herein is that, through the use of an established ACPI commands, the system and method disclosed herein is able to transition from a multi-thread mode of execution to a single thread mode of execution without the necessity of rebooting the computer system and without the risk of compromising the operation of the computer system. The system and method disclosed herein may involve the hot eject or hot release of each of the logical processor of the computer system, leaving only the physical processors of the computer system for execution of the software applications of the computer system.

Another technical advantage of the system and method disclosed herein is that the system and method is operable to evaluate the function of a hyper-threading-enabled processor over a time period as a basis for determining if the operation of the processor is being comprised by operating in a hyper-threading mode. As an alternative to evaluating the function of the processor on a snapshot basis, the system and method disclosed herein is operable to consider the performance over a time to period to determine if the processor's performance is negatively impacted by processing instructions in hyper-threading mode. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of hardware and software elements of a computer system;

FIG. 2 is a diagram of an ACPI module and an ACPI Table;

FIG. 3 is a flow diagram of a method for disabling the hyper-threading function of a processor; and

FIG. 4 is a flow diagram of a method for disabling the logical processors of a computer system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

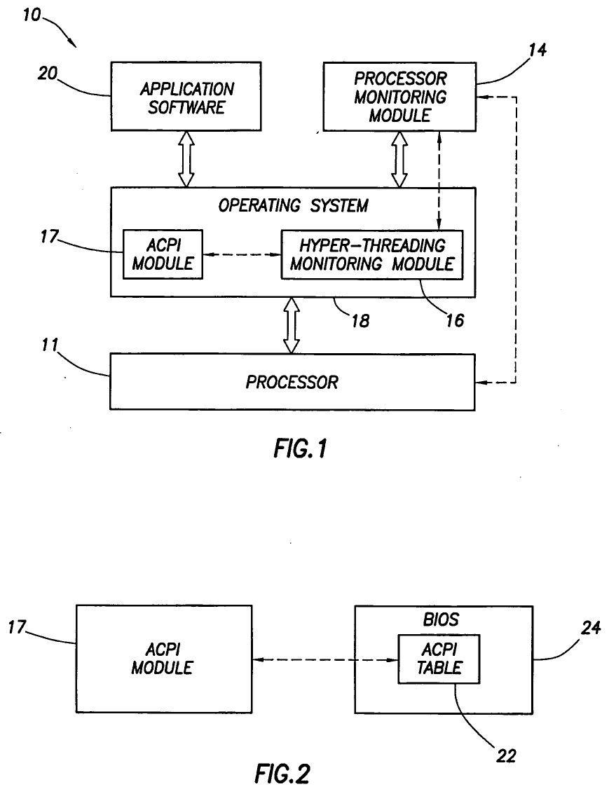

Shown in FIG. 1 is a diagram of hardware and software elements of a computer system, which is indicated generally at 10. Included in FIG. 1 is a depiction of the communication links between the hardware and software elements of the computer system. Computer system 10 includes a processor 11, communicates and executes the software of an operating system 18. Operating system software 18 includes a hyper-threading monitoring module 18 and an ACPI module 17. Operating system 18 communicates with and supports application software of the computer system, including application software 20 and processor monitoring module 14. Computer system 10 may include additional instances of application software. The dashed lines in FIG. 1 are indicative of data flow between certain elements of FIG. 1. As indicated in FIG. 1, processor monitoring module 14 retrieves data concerning the operation of processor 11. Processor monitoring module 14 communicates this data to hyper-threading monitoring module 16. On the basis of the reported performance data from processor monitoring module 14, hyper-threading monitoring module 16 may initiate the disabling of hyper-threading in processor 11.

In operation, processor monitoring module 14 measures, collects, and transmits data concerning the operation of processor 11. One example of a processor monitoring module is the Intel® VTune™ Analyzer product of Intel Corporation of Santa Clara, Calif. Processor monitoring module 14 collects data concerning the performance metrics of the processor. The collected data may include data concerning the number or percentage of cache misses and other indicators of resource contention in the processor. If the processor 11 is experiencing a degraded performance condition as a result of executing a software application that is not optimized for multi-threaded processing, for example, data that reflecting the poor performance condition of the processor will be collected by processor monitoring module 14.

With respect to data concerning the number of cache misses, an excessive number or percentage of cache misses, for example, may indicate that two or more threads of a single software application are repeatedly attempting to access the same set of processor resources. As an example, as a result of a series of cache misses, the cache may be populated as part of and during the execution of a first thread of a software application. When a second thread of a software application is executed, the processor may also experience a series of cache misses as a result of the cache being populated with data from the execution of the first thread of the software application. Processor monitoring module 14 may collect other data that reflects resource contention in the processor, including data indicative of I/O contention among the I/O resources available to the processor.

As indicated by the dashed line between processor monitoring module 14 and hyper-threading monitoring module 16, some or all of the data collected by processor monitoring module is passed to the hyper-threading monitoring module. Hyper-threading monitoring module 16 processes the data collected by processor monitoring module 14 to determine if hyper-threading should be disabled on the processor to force the processor to execute the software according to a single thread execution mode. Hyper-threading monitoring module 16 determines if the performance of the processor is being degraded by the multi-threaded execution of the application software. This determination by hyper-threading monitoring module 16 is typically accomplished by monitoring the data collected by processor monitoring module 14 over a time period to determine if the performance of the processor is degraded over an extended period of time. Hyper-threading monitoring module may make a quantitative comparison between the performance metrics of the processor and a standard set of performance metrics of a processor that is executing a software application that is optimized for multi-threaded execution.

If hyper-threading monitoring module 16 determines that multi-threading processing in processor 11 should be disabled, hyper-threading module 16 causes the ACPI (Advanced Configuration and Power Interface) of the computer system to initiate a hot eject or hot release of each logical processor of the computer system. The ACPI function and functionality of the computer system is shown in FIG. 1 as ACPI module 17 in operating system 18. The ACPI functionality of a computer system includes an ACPI Table, which is provided by the BIOS of the computer system and includes a listing of the devices of the computer system and the possible power states for the devices. The ACPI Table includes an identification of each physical and logical processor of the computer system. Shown in FIG. 2 is a diagram of the data flow between ACPI module 17 and the ACPI Table 22 of BIOS 24.

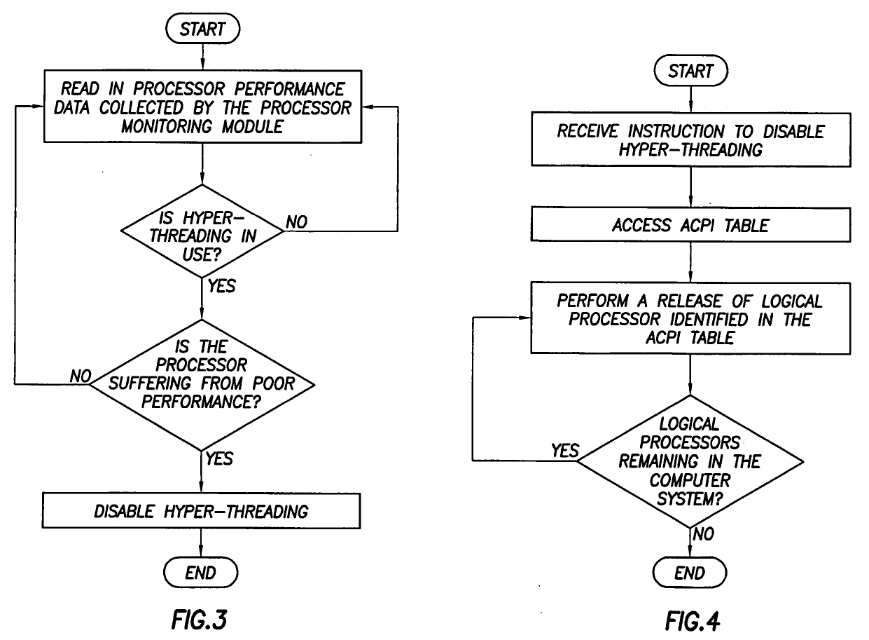

Shown in FIG. 3 is a flow diagram that depicts a series of steps for disabling the hyper-threading function of a processor if the performance of the processor is being compromised by the multi-threaded execution of a software application. At step 30, the hyper-threading monitoring module reads in processor performance data that was collected by processor monitoring module. At step 32, it is determined if hyper-threading is enabled. If it is determined at step 32 that hyper-threading is not enabled, the method depicted in FIG. 3 continues with the collection of performance data at step 30 and the method depicted in FIG. 3 loops between steps 30 and 32 until hyper-threading is enabled in the processor of the computer system.

If it is determined at step 32 that hyper-threading is enabled in the computer system, the flow diagram continues with step 34, which involves a determination within hyper-threading monitoring module 16 of whether the performance of the processor is being degraded by the execution of a software application in a multi-threaded execution mode. If it is determined at step 34 that the performance of the processor of the computer system, as measured over a measurement period, is not being negatively affected by the execution of a software application in a hyper-threading mode, there is no need to disable hyper-threading and the flow diagram continues at step 30 with the collection of additional performance data from the processor. As described, the determination at step 34 that the performance of the processor is being negatively affected may be made on the basis of performance data collected over a time period.

If it is determined at step 34 that the performance of the processor is negatively affected by the execution of a software application in hyper-threading mode, the hyper-threading mode of the processor is disabled at step 36, causing the processor to execute the software application with a single execution thread. One technique for disabling hyper-threading in the processor is to perform a hot release or hot eject of each logical processor in the computer system. The ACPI functionality of the computer system identifies each logical processor of the computer system and performs a hot release with respect to each logical processor until only physical processors remain in the computer system. After hyper-threading has been disabled in the computer system, the method depicted in FIG. 3 ends.

Shown in FIG. 4 is a flow diagram of a method for disabling hyper-threading. At step 40, an instruction is received or a determination is made that hyper-threading is to be disabled in the computer system. At step 42, the ACPI functionality of the computer system accesses the ACPI table of the computer system. The ACPI table of the computer system includes an identification of each logical processor in the computer system. At step 44, the ACPI functionality of the computer system initiates a hot eject or hot release of a logical processor of the computer system. A hot eject or hot release of a logical processor is characterized by the transition of the functions of the logical processor to another processor without compromising the function or data integrity of the computer system and without the necessity of rebooting the computer system. Following the release of the logical processor, it is determined at step 46 if additional logical processors remain in the computer system. If additional logical processors remain in the computer system, processing continues at step 44 with the release of additional logical processors. The method depicted in FIG. 4 loops between steps 44 and 46 until each logical processor of the computer system has been released, leaving only physical processors remaining in the computer system.

The system and method disclosed herein provides a technique for identifying a processor that is suffering from a substandard performance condition as a result of attempting to execute a software application in a hyper-threading or multithreading execution mode. Upon identifying this condition, the hyper-threading condition in the processor is disabled, which may be accomplished by disabling each of the logical processors in the computer system and without rebooting the computer system. Following the disabling of the hyper-threading condition, the processor or processors of the computer system execute software according to a single thread execution mode.

In the example of the present disclosure, hyper-threading monitoring module 16 is shown as being element of the operating system 18 of the computer system. It should be recognized, however, that hyper-threading monitoring module 16 may exist at other locations within the software and hardware architecture of the computer system. As an example, hyper-threading monitoring module 16 may exist outside of operating system 18 as a software utility that runs as application software or utility software that is supported by the operating system. It should be recognized that system and method disclosed herein is not limited in its application to the system architecture disclosed herein. It should also be recognized that the system and method described herein is not limited in its application to single processor computer systems. Rather, the system and method disclosed herein may likewise be applied in multiprocessor computer systems. Although the present disclosure has been described in detail, it should be understood that various changes, substitutions, and alterations can be made hereto without departing from the spirit and the scope of the invention as defined by the appended claims.

What is claimed is:

1. A method for disabling hyper-threading functionality in the processor of a computer system, comprising:
collecting data concerning the performance the processor of the computer system;
transmitting the collected data concerning the performance of the processor of the computer system to a hyper-threading monitoring module;
determining whether the performance of the processor is being negatively affected by the execution of one or more software applications in a multi-threaded execution mode; and
disabling each logical processor of the computer system if it is determined that the performance of the processor is being negatively affected by the execution of one or more software applications in a multi-threaded execution mode.

2. The method for disabling hyper-threading functionality in the processor of a computer system of claim 1, wherein the step of disabling each logical processor comprises the steps of:
disabling a logical processor of the computer system;
determining if additional logical processors exist that have not yet been disabled; and
repeating the steps of disabling a logical processor of the computer system and determining if additional logical processors exist that have not yet been disabled until each logical processor of the computer system has been disabled.

3. The method for disabling hyper-threading functionality in the processor of a computer system of claim 2, wherein the step of disabling a logical processor of the computer system comprises the step of causing the ACPI functionality of the computer system to release the logical processor.

4. The method for disabling hyper-threading functionality in the processor of a computer system of claim 1, wherein the step of collecting data concerning the performance the processor of the computer system comprises the step of collecting data concerning cache misses in the processor of the computer system.

5. The method for disabling hyper-threading functionality in the processor of a computer system of claim 1, wherein the step of collecting data concerning the performance the processor of the computer system comprises the step of collecting data concerning contention for resources of the processor.

6. The method for disabling hyper-threading functionality in the processor of a computer system of claim 1,
wherein the step of collecting data concerning the performance the processor of the computer system comprises the step of collecting data concerning contention for resources of the processor; and
wherein the step of determining whether the performance of the processor is being negatively affected by the execution of one or more software applications in a multi-threaded execution mode comprises the step of evaluating data concerning the contention for resource of the processors as a basis for determining if the performance of the processor is being negatively affected by the execution of one or more software applications in a multi-threaded execution mode.

7. The method for disabling hyper-threading functionality in the processor of a computer system of claim 1, wherein the step of determining whether the performance of the processor is being negatively affected by the execution of one or more software applications in a multi-threaded execution mode comprises the step of evaluating data reflecting the performance of the processor over a period of time.

8. A system for monitoring and disabling the hyper-threading functionality of a processor of a computer system, comprising:
a processor monitoring module operable to collect data concerning the performance of the processor; and
a hyper-threading monitoring module operable to determine, on the basis of the processor performance data, if hyper-threading functionality in the processor should be disabled.

9. The system of claim 8, further comprising ACPI functionality within the computer system, wherein the ACPI functionality is operable to disable the hyper-threading functionality of the processor of the computer system following a request from the hyper-threading monitoring module to disable the hyper-threading functionality of the processor.

10. The system of claim 9, wherein the ACPI functionality is operable to disable the hyper-threading functionality of the processor by disabling each logical processor of the computer system.

11. The system of claim 8, wherein the processor monitoring module is operable to collect data concerning cache misses experienced by the processor of the computer system.

12. The system of claim 8, wherein the processor monitoring module is operable to collect data concerning contention for processor resources.

13. The system of claim 8, wherein the hyper-threading monitoring module is operable to determine, on the basis of processor performance data collected and reflecting processor performance over a time period, if hyper-threading functionality in the processor should be disabled.

14. The system of claim 13, wherein the hyper-threading monitoring module determines whether hyper-threading functionality in the processor should be disabled on the basis of data concerning cache misses experienced by the processor of the computer system.

15. The system of claim 13, wherein the hyper-threading monitoring module determines whether hyper-threading functionality in the processor should be disabled on the basis of data concerning contention for processor resources.

16. A method for disabling hyper-threading in the processor of an information handling system, comprising the steps of:
identifying degraded processor performance in the system; and
disabling each logical processor in the computer system without rebooting the computer system, whereby only physical processors remain in the computer system.

17. The method for disabling hyper-threading in the processor of an information handling system of claim 16, wherein the step of disabling each logical processor comprises the step of causing ACPI functionality of the information handling system to identify and release each logical processor of the information handling system.

18. The method for disabling hyper-threading in the processor of an information handling system of claim 16, wherein the step of identifying degraded processor comprises the steps of:
collecting data concerning processor performance; and
evaluating the collected data to determine if the processor is operating in a degraded condition as a result of multi-threaded execution in the processor.

19. The method for disabling hyper-threading in the processor of an information handling system of claim 16, wherein the step of identifying degraded processor performance comprises the step of identifying degraded processor performance on the basis of data concerning cache misses experienced by the processor.

20. The method for disabling hyper-threading in the processor of an information handling system of claim 16, wherein the step of identifying degraded processor performance comprises the step of identifying degraded processor performance on the basis of data concerning contention for processor resources.
